(19) United States
(12) Patent Application Publication
(10) Pub. No.: US 2007/0126416 A1
(43) Pub. Date: Jun. 7, 2007

(54) Displacement Sensor Systems and Methods

(75) Inventors: Haihong Zhu, Atlanta, GA (US); Michael Orndorff, Douglasville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Sentrinsic LLC, Atlanta, GA (US)

(21) Appl. No.: 11/671,929

(22) Filed: Feb. 6, 2007

Related U.S. Application Data
(63) Continuation-in-part of application No. 11/259,665, filed on Oct. 26, 2005.
(60) Provisional application No. 60/622,285, filed on Oct. 26, 2004.
(60) Provisional application No. 60/765,375, filed on Feb. 6, 2006.

(51) Int. Cl. G01B 7/30

(52) U.S. Cl. 324/207.17

(57) ABSTRACT

Various embodiments of displacement systems and methods are disclosed. One method embodiment, among others, includes providing a pulsed excitation signal to a single location of a resistive member with reference to another location of the resistive member of a displacement sensor, and responsive to the excitation signal, measuring a voltage on a non-contacting signal probe in moveable relationship to the resistive member.

### CROSS-REFERENCE TO RELATED APPLICATIONS

This application is a continuation-in-part of U.S. utility application entitled, “Displacement Sensor,” having Ser. No.11/259,665, filed Oct. 26, 2005, which claims priority to U.S. provisional application entitled, “Displacement Sensor Embedded Cylinder and Novel Displacement Sensor,” assigned Ser. No. 60/622,285, and filed on Oct. 26, 2004, both of which are entirely incorporated herein by reference.

This application claims priority to copending U.S. provisional application entitled, “Novel extensions to CCPT sensor technologies incorporating low power, long range, and simpler conditioning/processing methods; and applicability to potentiometric sensors,” having Ser. No. 60/765,375, filed Feb. 6, 2006, which is entirely incorporated herein by reference.

### TECHNICAL FIELD

The present disclosure is generally related to displacement sensors systems, and, more particularly, is related to non-contacting displacement systems and methods.

### BACKGROUND

Displacement sensors can be widely used in a number of industrial applications. Conventional displacement sensors have a variety of structures and working principles. For example, conventional displacement sensors include contacting potentiometers (e.g. resistance sensors), inductance sensors (e.g. Linear Variable Differential Transformer (LVDT) sensors and eddy current sensors), and non-contacting potentiometer displacement sensors.

Displacement sensors are often embodied as part of a larger system, with such a system including a mechanism for generating a signal that powers or activates (e.g., excitation signal) the components of the displacement sensor, as well as signal conditioning components or devices. As to signal excitation schemes, a sinusoidal waveform input is typically used. The signal conditioning components or devices are typically used to receive a measurement signal from the displacement sensor and condition the signal to improve the quality or integrity of the signal. For instance, such a received signal often suffers from common noise, strength, and interference that limit the effectiveness of the signal output. Accordingly, signal conditioning components are used to condition the signal (e.g., voltage signal) to maximize the usefulness of the signal. For a sinusoidal waveform input, the signal conditioning techniques are well established. These techniques are available in many off-the-shelf components that can condition LVDT (inductive) sensors.

While these techniques have their advantages, problems may arise with signal conditioning using sinusoidal input waveforms. For instance, using sinusoidal input waveforms with displacement sensors often requires a precision sine wave generator, which can be costly and susceptible to environmental interference. Further, the output signal (excitation) from such conventional signal conditioning components is a sine waveform. Therefore the input signal from the sensor is also a sine waveform, which often requires costly, specialized electronics to demodulate the sine waveform and translate the amplitude of the sine waveform into a corresponding DC voltage signal.

### SUMMARY

Embodiments of the present disclosure provide displacement sensor systems and methods.

One system embodiment, among others, comprises a displacement sensor having a resistive member and a non-contacting signal probe; and a processor configured to provide a pulsed excitation signal to a single location of the resistive member, the processor further configured to measure a voltage on the probe caused by the excitation.

One method embodiment, among others, comprises providing a pulsed excitation signal to a single location of a resistive member with reference to another location of the resistive member of a displacement sensor, and responsive to the excitation signal, measuring a voltage on a non-contacting signal probe in moveable relationship to the resistive member.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a displacement sensor (DS) system embodiment.

FIGS. 2A-2B are combination block and schematic diagrams that illustrate a basic operation of the DS system shown in FIG. 1.

FIG. 3 is a schematic diagram that illustrates an equivalent circuit corresponding to the DS system shown in FIG. 2A-2B.

FIG. 4 is a schematic diagram that illustrates an alternative equivalent circuit to the equivalent circuit shown in FIG. 3.

FIG. 5 is a flow diagram that illustrates one method embodiment corresponding to the technique illustrated in FIG. 3.

FIG. 6 is a flow diagram that illustrates one method embodiment corresponding to the technique illustrated in FIG. 4.

FIGS. 7A-12B are combination schematic and cross-sectional diagrams that illustrate various DS system embodiments.

FIGS. 13A-13B are schematic diagrams that illustrate one displacement sensor embodiment.

FIGS. 14A-14B are schematic diagrams that illustrate one displacement sensor embodiment.

FIG. 15 is a flow diagram that illustrates on DS method embodiment.

### DETAILED DESCRIPTION

Various embodiments of displacement sensor (DS) systems and methods are disclosed. Such embodiments include more advanced signal conditioning methods based on pulsed or non-continuous wave (e.g., square waveform) excitation that overcomes the above-described shortcomings of continuous waveform excitation and associated signal conditioning techniques. There have been some square waveform excitation technique disclosed and applied in the past to conventional displacement sensors, but there exists several distinctions between such systems and the DS systems as disclosed herein. For instance, the excitation in some embodiments of DS systems is applied at one end of a resistive member relative to or with reference to another location (e.g., ground) of the resistive member of the displacement sensor, whereas two inversed excitations are applied at each end of a resistive member in conventional systems. Further, in some embodiments of DS systems, the amplitude of the excitation (peak to peak) is fixed, whereas conventional solutions requires continuous adjustment of the excitation amplitudes at both ends of the resistive member. In addition, the signal voltage on a signal probe used in some embodiments of DS systems is the only one being processed, while in conventional solutions, an adjustment of the excitation amplitudes is required at two ends to achieve a null (zero) voltage on the signal probe, with further processing of these two excitation amplitudes. This latter conventional method may not only increase the processing time (limiting the bandwidth of the sensor), but may also increase the complexity of any associated hardware and software.

Certain embodiments of DS systems employ signal conditioning in cooperation with displacement sensors that perform according to capacitance coupled resistive sensing (CCRS) techniques. Displacement sensors, in general, have a variety of structures and working principles. Two common types of displacement sensors include resistance sensors (also known as potentiometers) and inductance sensors (LVDT, eddy current sensors, etc.). Though certain embodiments of DS systems may be used in such conventional systems, CCRS represents a new type of displacement sensor technique, operating on a different working principle (e.g., a non-contacting potentiometric displacement sensor).

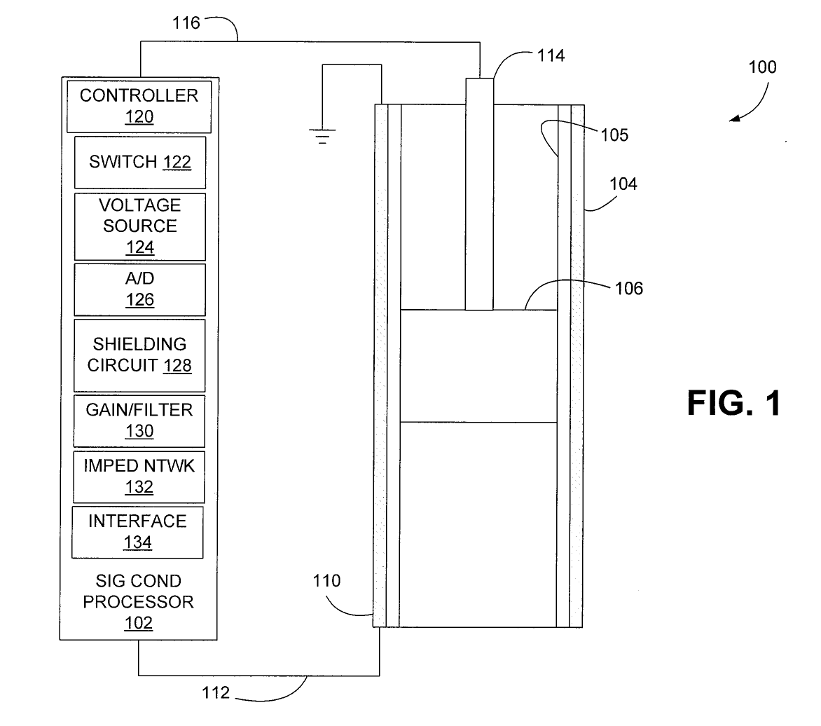

FIG. 1 is a schematic diagram of one embodiment of a DS system 100. The DS system 100 comprises a signal conditioning processor 102 communicatively coupled to a displacement sensor 104 (shown in cross-section). The displacement sensor 104 is generally housed in a cylindrical enclosure (not shown), though not limited to such geometries. The displacement sensor 104 comprises a hollow electrically non-conductive tube 105 housing a piston 106 (also referred to herein as a signal probe, pickup, pickup head, and the like), and a resistive member 110 that receives a non-continuous (or continuous in some embodiments) waveform over connection 112 from the signal conditioning processor 102. The displacement sensor 104 also includes, in some embodiments, a coaxial cable 114 that serves as a frontier signal transferring mechanism for an output signal over connection 116 to the signal conditioning processor 102. The output signal provided over connection 116 can be used to represent the location of a signal pickup (or signal probe) along a length defined by a portion of the resistive member 110 between first and second electrical terminals defining the length of the resistive member 110.

In one embodiment, the signal probe comprises the electrically conductive piston 106, and thus piston and signal probe are terms that are used interchangeably within the present disclosure. The diameter of the piston 106 with respect to that of the inner surface of non-conducting tube 105 may, for example, provide a small gap between the outer surface of the piston 106 and the inner surface of the tube 105, such that the piston 106 is loosely fitted and easily slides along the inner surface of non-conductive tube 105 while still maintaining a substantially constant distance from the resistive member 110. Note that the terms resistive member, resistive strip, resistive film, and the like, are used interchangeably within the present disclosure to connote similar functionality of the resistive member 110.

The resistive member 110 comprises, in one embodiment, a resistance film applied to the outer surface of the electrically non-conductive hollow tube 105. The resistive member 110 can be embodied as any relatively uniform, consistent, resistive element such as a film, a wire winding, a tube, etc. Further, the resistive member 110 may be embodied as a strip of resistive film placed or formed axially along the tube 105 of the displacement sensor 104 instead of completely surrounding the tube, or as a rectangular strip placed or formed along a flat surface. Electrically non-conductive tube 105 may comprise, for example but not limited to, a glass tube or a plastic tube, etc. The resistive member 110 can also be in the shape of a hollow tube, though not limited to such geometries.

The signal provided over connection 112 to the displacement sensor 104 is coupled across electrical terminals (not shown) located on each side of the resistive member 110. Further description of such terminals can be found in the parent application cross-referenced in the beginning of this disclosure. Thus, a signal source from signal conditioning processor 102 provides an alternating voltage to resistive member 110 through such electrical terminals.

The resistive member 110 and the signal probe 106 are not electrically contacting each other and are capacitively coupled to each other. In some embodiments, the frontier signal transfer mechanism may be an electrically conductive strip protected by the shielding layer and thus the coaxial cable 114 may be omitted, in which case acquisition of the measurement voltage is implemented according to various methods described below.

The signal conditioning processor 102, in one embodiment, comprises a controller (e.g., a micro-controller) 120, excitation switch 122, voltage source 124 (e.g., DC or AC), analog-to-digital converter (A/D) 126, shielding circuit 128, gain/filter (e.g., gain and/or filter) circuitry 130, an impedance network 132, and a communications interface 134. In some embodiments, the signal conditioning processor 102 may be configured with fewer components and/or different components. For instance, in some embodiments, the impedance network 132 is omitted. The controller 120 is configured in one embodiment to provide a waveform to the excitation switch 122. The excitation switch 122 is coupled to the voltage source 124 that, responsive to instructions from the controller 120, switches the excitation switch 122 to enable and disable the signal waveforms (e.g., square wave) to the displacement sensor 104. In some embodiments, the controller 120 may be configured to provide the square waveform without the use of the excitation switch 122 and/or voltage source 124. The waveforms provided by the signal conditioning processor 102 may comprise one or more of a plurality of different waveforms, including sinusoidal, square waveform, or other voltage varying waveform.

The signal conditioning processor 102 further comprises the shielding circuit 128 to output a buffered shielding voltage. The buffered shielding voltage is same as the voltage received from the signal probe 106. The buffered shielding voltage is provided to the buffered shielding strips (explained further below) to provide a better shielding effect than simple grounded shielding techniques. Specifically, the voltage measurement returned through connection 116 from the sensor 104 is fed into the shielding circuit 128. The shielding circuit 128 can comprise, but not limited to, a voltage follower. The shielding circuit 128 takes the voltage measurement from the sensor 104 and outputs a voltage that is the same as the voltage measurement (with a stronger driving ability than the original signal) to the buffered shielding strips inside the shielding layers (explained further below). The buffered shielding scheme is similar to well-established active shielding methods, which can provide a better shielding effect compared to passive grounded shielding. From a circuit point of view, a difference between the passive grounded and buffered shielding is that the passive grounded shielding provides a grounded (0 volt) shielding coverage while the buffered shielding provides a voltage (same as or similar to the signal voltage to be shielded) shielding coverage. In addition, the mentioned coaxial cable 114 can also use a buffered shielding instead of simply grounding the shielding layer of the cable.

Signals received by the displacement sensor 104 are, in some embodiments, processed by the impedance network 132 (explained further below). The gain/filter stage 130 (which provides well-known filtering and amplification functionality) and the A/D converter 126 condition the received signals and convert the signals to the digital domain before passing the conditioned signal to the communications interface 134. The communications interface 134 conditions the signal for communication to a user or device according to one or more configured protocols.

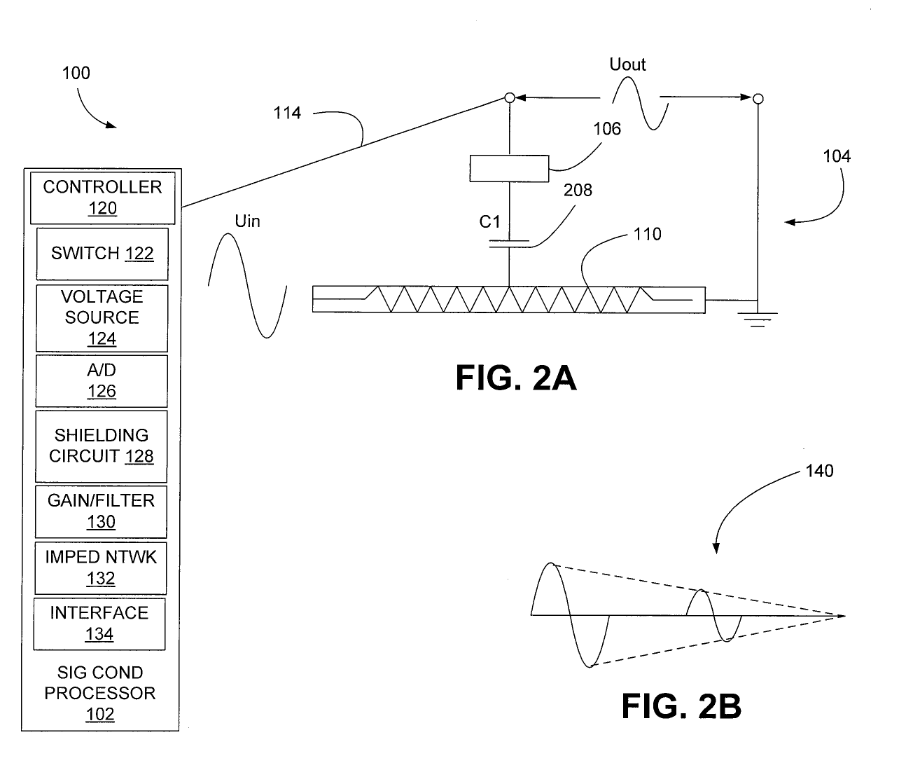

FIG. 2A is a combination block and schematic diagram that illustrates a basic operation (for a sinusoidal waveform) of the DS system 100 shown in FIG. 1. In operation, the signal conditioning processor 102 provides an alternating voltage, Uᵢₙ, which is applied to one end (e.g., a single location or single point of contact) of the resistive member 110, though not limited to a single location. The amplitude of the alternating voltage, though provided in one embodiment as a constant peak-to-peak amplitude, varies in amplitude across the length of the resistive member 110, as depicted in the amplitude graph 140 shown in FIG. 2B. As the signal probe 106 moves (activated in response to the excitation signal, Uᵢₙ) along the resistive member 110 in non-contact fashion, the alternating voltage is coupled by the capacitance (represented symbolically by capacitor 208) between the signal probe 106 and the resistive member 110. Therefore, the signal output (sensed signal, Uₒᵤₜ) provided over coaxial cable 114 represents the position of the signal probe 106.

The displacement sensor 104 can operate on the same excitation and output voltages as Linear Variable Differential Transducers (LVDTs). Similarly, in some embodiments, the same signal conditioning principles and methods used for LVDTs can be used for the displacement sensor 104 (e.g., in lieu of signal conditioning processor 102, or in some embodiments, the signal conditioning processor can be configured for such operation). There are many LVDT signal conditioners on the market, offered by many different vendors. Given the working principle of LVDTs, the driving and conditioning circuitry require a sine wave excitation source. Therefore, conventional signal conditioners typically require a precision sine wave generator, which are relatively costly and more sensitive to external environmental factors. Further, the excitation is a sine waveform, which creates a corresponding sine wave output signal. Sine wave output signals require specialized electronic circuitry to demodulate the sine waveforms and translate the amplitude of the waveform into a corresponding DC voltage signal.

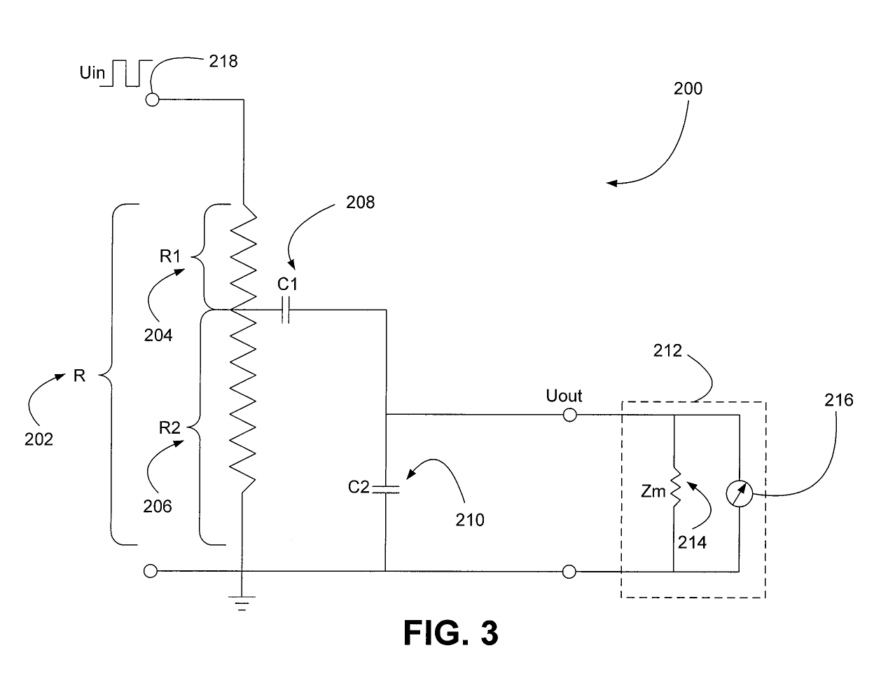

With these challenges in mind, the DS systems 100 described herein implement an alternative approach for use with displacement sensors of the same or similar configuration shown in FIG. 1, namely that of providing a pulsed or non-continuous type waveform to the displacement sensor 104. That is, instead of applying an alternating voltage as a sine waveform, a square waveform is applied across the resistive member 110. Such a technique can deliver several advantages when compared to traditional LVDT signal conditioning, including significant reduction in the costs and complexity of the processing unit (e.g., signal conditioning processor 102), increased range of working bandwidth, and reduction in the susceptibility of the output signal to noise. An explanation of certain approaches used in the DS systems 100 described herein are described below in association with FIGS. 3-6.

FIG. 3 is a schematic diagram that illustrates an equivalent circuit 200 corresponding to the DS system 100, and in particular, illustrates one exemplary square wave conditioning technique implemented by an embodiment of the DS system 100. The equivalent circuit 200 includes the equivalent resistance 202 of the resistive member 110, and includes a first resistance R1 204 and a second resistance R2 206. The equivalent circuit 200 also includes the equivalent capacitance C1 208 between the signal probe 106 and the resistive member 100, and the equivalent capacitance C2 210 introduced when linking a shielding layer of the coaxial cable 114 to signal ground. An equivalent circuit 212 is also shown for the signal conditioning processor 102, including a measurement impedance, Zm 214, of the signal conditioning processor 102, and a voltage signal measured from the sensor, Uₒᵤₜ 216. The excitation signal input comprises Uᵢₙ provided at terminal 218. Responsive to a step (i.e. rising and holding, which is the first half of a square wave) excitation voltage, Uₒᵤₜ 216 is also a step waveform. After Uₒᵤₜ fully stabilizes (e.g., reaches its peak amplitude), it can be calculated (assume Zm is very large, such as through using an operational amplifier) as:

$${U}_{out} = \frac{{C}_{1}}{{C}_{1} + {C}_{2}} \cdot \frac{{R}_{2}}{( {R}_{1} + {R}_{2} )} {U}_{in} \qquad ( 1 )$$

Thus, in one embodiment of the DS system 100, the approach is to excite one end of the resistive member 110 with a step (i.e. rising and holding, which is the first half of a square wave) excitation voltage. After the output voltage Uₒᵤₜ fully stabilizes (e.g., reaches the peak amplitude), the voltage Uₒᵤₜ is measured (i.e., sampled) and converted into digital form by the analog-to-digital converter 126 and sent to the micro-controller 120 for processing (e.g. digitally filtering and outputting to user though standard or proprietary communication protocols). Any time after the analog-to-digital conversion is performed, the excitation voltage can be terminated (i.e. falling and holding to ground, which is the second part of a square wave). One having ordinary skill in the art should understand, given the benefit of this disclosure, that the analog-to-digital converter (A/D 126), the controller 120, and the interface 134 can all be embedded in a single digital signal processing chip in some embodiments, as is true for other combinations of components of the signal conditioning processor 102. Further, in some embodiments, the functional circuits (e.g. A/D 126, excitation switch 122, etc.) in the signal conditioning processor 102 are controlled and coordinated to work together by the controller 120.

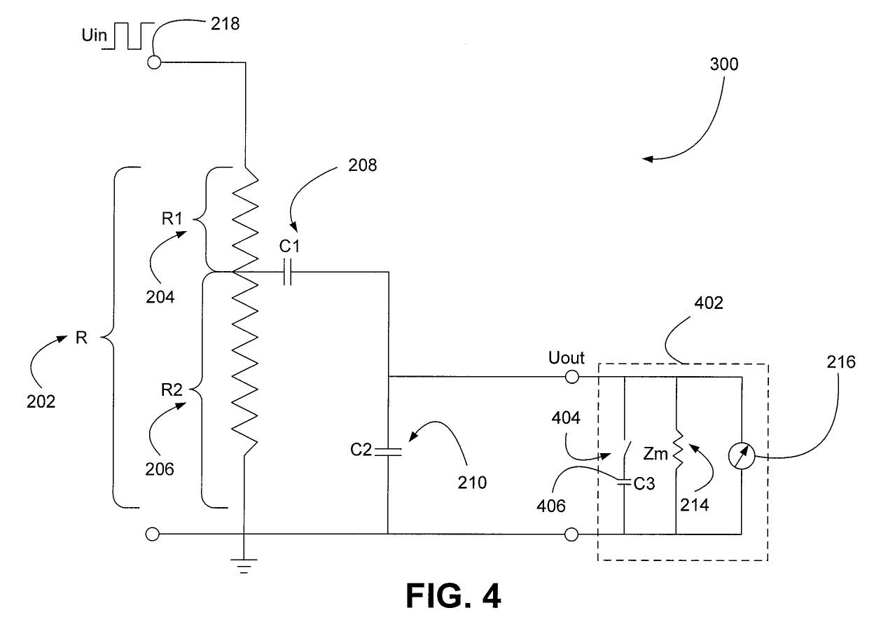

FIG. 4 is a schematic diagram that illustrates an equivalent circuit 300 corresponding to the DS system 100, and in particular, illustrates another exemplary square wave conditioning technique in cooperation with an impedance network (e.g., impedance network 132) implemented by an embodiment of the DS system 100. The equivalent circuit 300 is similar to that shown in FIG. 3, with the addition of the adjustable impedance circuit 402 comprising a switch 404 and capacitor 406 coupled to the switch 404. By inspecting equation 1 above, it is observed that the voltage measurement Uₒᵤₜ changes as C1 208 changes. Since C1 208 is the equivalent capacitance between the signal probe 106 and the resistive member 110, C1 208 is subject to a certain amount of variance if the sensor is under a vibrating working environment, albeit usually very small. To provide a more accurate measurement solution, one or more capacitors, such as capacitor C3 406, of known value can be added. In two adjacent implementations of the above-mentioned signal processing, the first implementation does not include C3, and the second implementation does include C3. Then, the following equation set (2) applies.

$$\{ \begin{matrix}{U}_{out} = \frac{{C}_{1}}{{C}_{1} + {C}_{2}} \cdot \frac{{R}_{2}}{( {R}_{1} + {R}_{2} )} {U}_{in} \\ {U}_{out} = \frac{{C}_{1}}{{C}_{1} + {C}_{2} + {C}_{3}} \cdot \frac{{R}_{2}}{( {R}_{1} + {R}_{2} )} {U}_{in}\end{matrix} \qquad ( 2 )$$

Note that C2 210 (e.g., caused by linking the shielding of the coaxial cable to the ground) is typically known and does not vary significantly. In the equation set (2) there are two unknowns: C1 208 and R2 206. It is easy to solve this equation set to find R2 206, which represents the position of the signal probe on the resistive member 110. Also note that C3 406 does not necessarily have to be a capacitor, but can be any other component that can change measurement impedance (e.g. resistor). Additionally, an operational amplifier may be used to increase the measurement impedance Zm 214.

An assumption is made in the above-described processes corresponding to the equivalent circuits 300 and 400 that during the adjacent two measurements, C1 will not change. This is true since, for each implementation, the total consumed time is less than 10 microseconds (10⁻⁵ seconds), and can be easily reduced to 10⁻⁶ seconds or less. During this short period of time, essentially any mechanical system can be deemed as stationary, which allows for C1 208 to be assumed constant during two adjacent implementations.

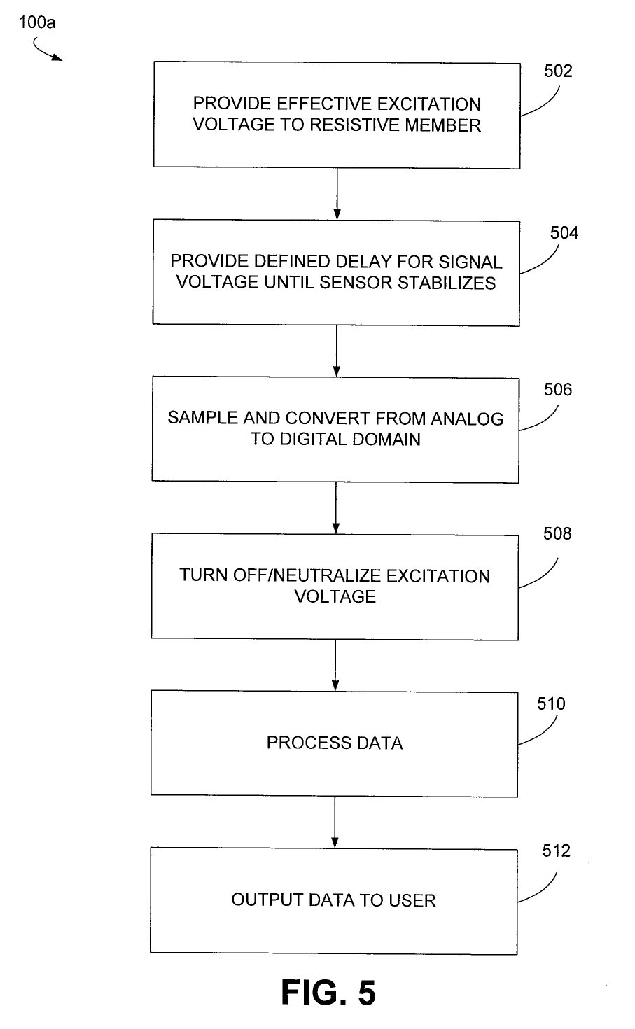

Having described some underlying principles of various embodiments of the DS system 100, it should be appreciated that one DS method embodiment 100a, (corresponding to the techniques illustrated in association with FIG. 3) shown in FIG. 5, comprises providing an excitation voltage to the resistive member (502). In one embodiment, the controller 120 is configured to turn on the switch 122 (or the switch 122 can perform this function autonomously in some embodiments). In some embodiments, the switching may be implemented directly by the controller 120 or any device with an on-off function. Continuing the description of method 100a, a delay used to wait until the signal voltage from the sensor 104 stabilizes is imposed (504). After the delay, the analog signal voltage from the displacement sensor 104 is sampled and converted by the A/D converter 126 (506), resulting in a digital value. The value is sent to the controller 120, and the controller 120 instructs the excitation switch 122 to link the excitation terminal to the electrical ground (0 volt) (508). In some embodiments, the controller 120 serves not only a logic controller but also a computational processing unit. The method 100a further comprises processing (e.g., filtering) the digital value (510), and the data is output to a device or user via interface 134 using a desired communication protocol (512). In some embodiments, before the excitation voltage is applied, the electric charge remaining on the signal probe is fully discharged through grounding the connection 114 by the controller 120 or a controllable grounding switch (not shown).

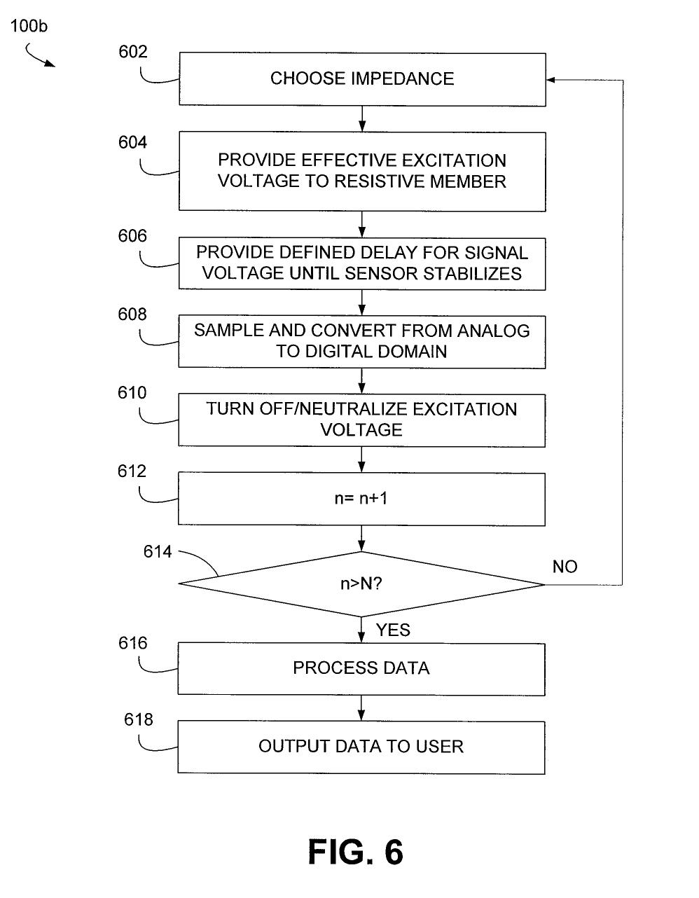

Another method embodiment, 100b, is described below as it relates to the technique illustrated in FIG. 4. Such a method 100b, shown in FIG. 6, comprises similar steps to that used in the method 100a described above, and hence an explanation of these similar steps except for their mere mention is omitted in the description for FIG. 6 for brevity. The method 100b comprises choosing a defined impedance (602) (e.g., the impedance can be programmed into the controller 120 or configured through instructions by the controller 120 based on user input or sensed performance or conditions), providing an excitation voltage to the resistive member (604), imposing a delay before the voltage measurement (606), sampling and A/D conversion (e.g., measurement) (608), and grounding or terminating the excitation voltage signal (610). Additionally, the method 100b comprises establishing a counter (612). For instance, to establish an equation set to solve N unknowns, N equations are needed. To get N independent equations, the above process (602-610) is implemented N times with different impedance each time. The method 100bcontinues by determining (by controller 120) whether the number of equations is N (614), and if not, returning to the process beginning at (602), otherwise, processing the data (e.g., solving the equation set) (616), and outputting the data (618).

The above-described processes corresponding to waveform generation and delivery encompasses a specific approach of using a square wave, periodic pulse as the excitation. This approach yields a predictable, output wave with an amplitude that is predictably proportional to the displacement of the pickup (or equivalently, signal probe 106, bridge, pickup head, etc.) relative to the length of the resistive member 110. In some embodiments, periodicity of the excitation wave can be omitted, which can provide greatly reduced power requirements, since in some embodiments, the resistive member 110 only needs to be energized long enough (usually less than 10⁻⁶ second) to saturate the capacitive coupling (e.g., capacitance 208) between the resistive member 110 and the signal probe 106 when a read is required.

For instance, an external trigger (not shown) can provide a signal to the signal conditioning processor 102 indicating that a read is desired, at which point a single square pulse could be sent along the resistive member 110. After an appropriate delay to ensure a stable, saturated signal is available at the signal probe 106, the signal conditioning processor 102 can read the signal. For stability, the signal conditioning processor 102 might actually send a set of pulses, allowing the signal conditioning processor 102 to obtain a set of reads to ensure stability and repeatability. The value returned by the signal conditioning processor 102 (e.g., to an acquisition system or device) may be an average of the obtained reads, or pulses may be sent by the signal conditioning processor 102 until such time as a given threshold of matching reads is obtained, or some other method to determine a valid read value from a set of, possibly differing, reads.

The trigger event may be a periodic signal from an external control system or programmable logic controller (PLC) indicating the system's desire for an updated value. Conversely, it may be a trigger from the displacement sensor 104 itself—for example the displacement sensor 104 may send a trigger signal upon movement. This would allow the excitation pulse and read to be performed only when the displacement sensor 104 has moved to a new value (and remaining in a sleep state during all times that there is no movement of the sensor, therefore no need for a new displacement value). In applications where the movement being measured only occurs during discrete times, this should allow the signal conditioning processor 102 to remain in a relatively dormant, lower-power standby mode and wake up only when there is movement in the system.

Having provided an overview of the various DS system and method embodiments, the following sections address additional embodiments with different configurations of displacement sensors 104. The following sensor embodiments are based on the following design guides: 1) there is at least one resistive strip (also referred to herein as resistive member), 2) there is at least one signal strip (e.g., strip, plate, etc.), 3) there are shielding layers near each signal probe and signal strip, but not necessarily between them, and 4) if using buffered shielding technology, the shielding layers comprise at least one buffered shielding strip; the buffered shielding strip should be supplied with a voltage that is the same or similar as the voltage on the closest signal strip or signal probe.

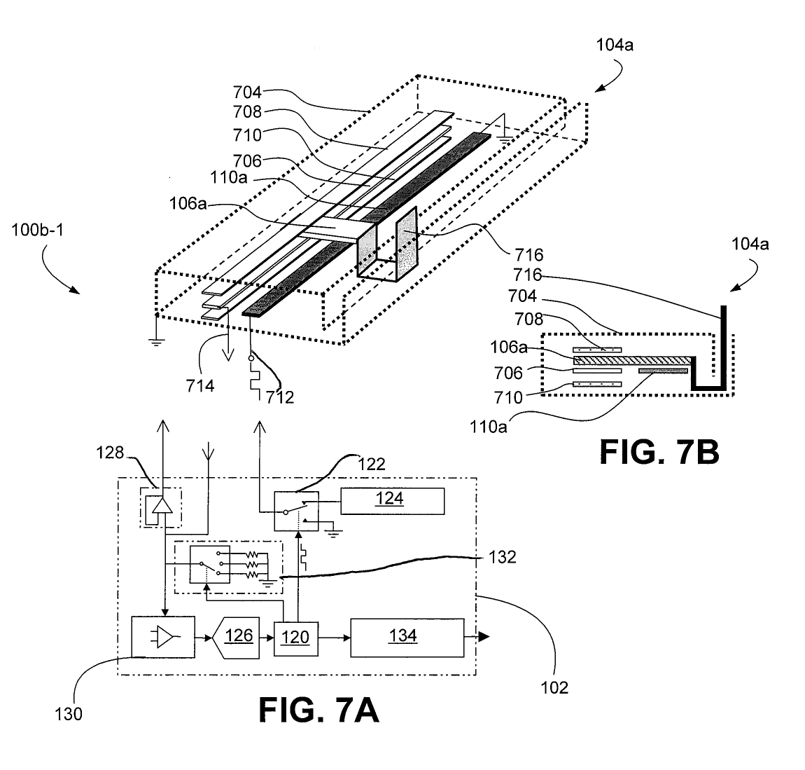

Referring to FIG. 7A, shown is a DS system embodiment 100b-1 (based on the underlying architecture and techniques shown in FIG. 4) comprising a signal conditioning processor 102 used in cooperation with an embodiment of a displacement sensor 104a. The signal conditioning processor 102 comprises components described above. Referring to the signal output portion of the signal conditioning processor 102, the controller 120 provides a signal waveform (e.g., square waveform) to the excitation switch 122, which is also coupled to a DC excitation voltage source 124. The controller 120 activates or instructs the excitation switch 122 to either output a non-zero excitation signal from the voltage source 124 or output electrical ground (0 volt). When the excitation switch 124 is enabled, a step up excitation voltage (i.e. rising and holding, which is the first half of a square wave) is provided to the displacement sensor 104a. A signal (voltage measurement) is returned by the displacement sensor 104a in response to the excitation voltage, and received at the gain/filter stage 130 for processing, including amplification and/or filtering. Additionally, the received signal encounters an adjustable (or fixed in some embodiments) impedance from the impedance network 132 in the manner described in association with the equivalent circuit 300 described in association with FIG. 4, and hence omitted here from discussion for brevity. Because of the presence of capacitance (e.g. C1 208 and C2 210, etc.), it takes some time for the voltage measurement to rise. Therefore, a delay is imposed to wait until the voltage measurement stabilizes. After the delay, the voltage measurement is measured (sampled) by the A/D converter 126, where the signal is converted from the analog domain to the digital domain, and then the data is passed to the controller 120. The excitation can be terminated or linked to ground at any time after the A/D conversion. The controller 120 records (e.g., in one or more registers or to memory (not shown)) the value of the voltage measurement corresponding to displacement of the signal probe 106a of the displacement sensor 104a. The measured value may be communicated to a user (e.g., via a display, audio, etc.) or to another device via communication interface 134, which may be configured to condition the signal for communication according to one or more protocols.

Having described one architecture embodiment of the signal conditioning processor 102, attention is directed to the displacement sensor 104a shown in perspective in FIG. 7A. As shown, the displacement sensor 104a comprises an enclosure 704 that at least partially surrounds a resistive member 110a, a signal strip 706, a substantial portion of the signal probe 106a, and shielding layers 708 and 710. The displacement sensor 104a comprises an input terminal 712 to receive the square waveform at one end of the resistive member 110a from the signal conditioning processor 102 and an output terminal 714 to return a voltage measurement signal to the signal conditioning processor 102. Input and output terminals, though shown in the figures that follow, are omitted in the corresponding discussion that follows for brevity. The signal probe 106a comprises a linking member 716 that provides a mechanism to couple movement of an object for which displacement is being measured to the signal probe 106a. In one embodiment, the resistive member 110a and the signal strip 706 are configured as non-conductive and conductive strips, respectively, though not limited to such structures or materials or material characteristics.

FIG. 7B shows a cross-sectional view of the displacement sensor 104a, which further illustrates the relative locations of the various structures within the enclosure 704. As shown, the enclosure 704 is configured in one embodiment as a “U” and “L” shaped configuration. The shielding layer 708 is disposed between a portion of the top inside surface of the enclosure 704 and a portion of the top surface of the signal probe 106a. The signal strip 706 and the resistive member 110a are approximately edge-wise adjacent each other, separated by a defined distance, and both components are disposed a defined distance beneath (and capacitively coupled to) the signal probe 106a. The signal probe 106a moves relative to the signal strip 706 and resistive member 110a, according to the movement of the object that is coupled to the linking member 716.

Several shielding layers 708 and 710 are deployed in some embodiments. The shielding layers 708 and 710 (as is true in other shielding layers described herein) each comprise 1) an electrical grounded conductive strip or, 2) an electrically conductive strip supplied with the buffered shielding voltage or, 3) both but with no contact between above two strips. In certain embodiments described herein, the arrangement of the shielding layers 708 and 710 abide by the following guidelines: 1) there is a shielding layer beside a signal strip and a signal probe, but not between the signal strip and the signal probe, and 2) if the shielding layer comprises both a grounded strip and a buffered shielding strip, the buffered shielding strip is closer to the signal strip or signal probe.

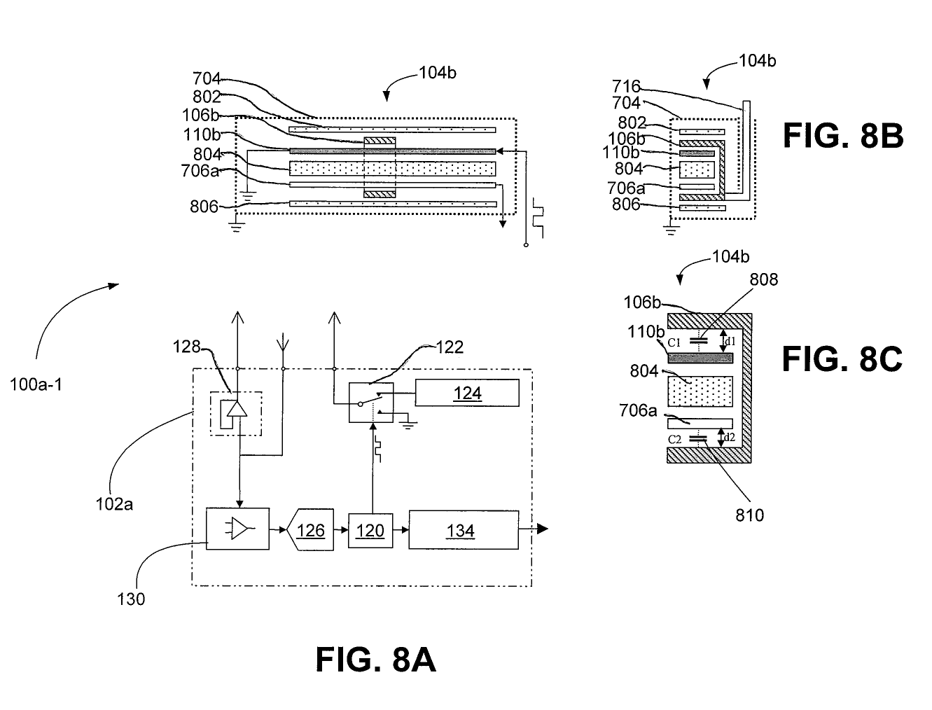

FIG. 8A is a left-side, cross sectional view, sliced along the longitude of the sensor 104b (e.g., a view from the left side of FIG. 8B). FIG. 8A illustrates another DS system embodiment 100a-1 (based on the underlying architecture and technique illustrated in FIG. 3) comprising a signal conditional processor 102a used in cooperation with an embodiment of a displacement sensor 104b. The signal conditioning processor 102b is similar to processor 102a, with the omission of the impedance network 132, and hence discussion of the same is omitted here for brevity. The displacement sensor 104b comprises the enclosure 704 as described above, along with shielding layers 802, 804, and 806, signal strip 706a and resistive member 110b, and signal probe 106b encompassed at least partially within the enclosure 704. In one embodiment, the signal probe 106b is a “U” shape, rigid, electrically conductive structure or a non-conductive structure with conductive material coated inside the “U”. The displacement sensor 104b also comprises the linking member 716 coupled to the signal probe 106b, in a manner similar to that described above. Referring to FIG. 8B, which is a cross-sectional view of the displacement sensor 104b, beneath the top inside surface of the enclosure 704 comprises several layers disposed from top to bottom, with the layers each separated a defined distance from an adjacent layer. For example, located a defined distance beneath the top inside surface of the enclosure 704 is the shielding layer 802, followed in order by a first portion of the signal probe 106b, the resistive member 110b, the shielding layer 804, the signal strip 706a, and a second portion of the signal probe 106b, followed by the shielding layer 806 and the bottom inside surface of the enclosure 704. The first portion of the signal probe 106b is joined to the second portion of the signal probe by a third portion aligned substantially perpendicular to the first and second portions. The resistive member 110b, shielding layer 804, and signal strip 706a are also located a defined separation distance away from the third portion of the signal probe 106b.

FIG. 8C comprises a cross-sectional view showing select features of the displacement sensor 104b with the effective capacitance between select layers symbolically represented with capacitor symbols, C1 808 and C2 810. In particular, shown in FIG. 8C is the first portion of the signal probe 106b located a distance d1 above, and capacitively coupled via C1 808 to, the resistive member (e.g., strip) 110b. Beneath the resistive member 110b is the shielding layer 804 followed by the signal strip 706a. A capacitance C2 810 exists between the signal strip 706a and the second portion of the signal probe 106b located a distance d2 beneath the signal strip 706a. In one embodiment, the resistive strip 110b, the shielding layer 804, and the signal strip 706a are made in one structure (e.g., a multi-layer printed circuit board PCB). The signal probe 106b, in one embodiment, is a rigid “U” structure. Therefore, (d1+d2) is constant, and hence the following relationship is observed:
C1=C10*C11/(C10+C11)=constant

In certain implementations, vibration causes d1 and d2 to change, but the sum (d1+d2) does not change, which yields the result that C1 208 (FIG. 2) will not change. Looking back to equation 1, since C2 810 is constant and C1 808 is constant according to above deduction, this embodiment provides good vibration resistance.

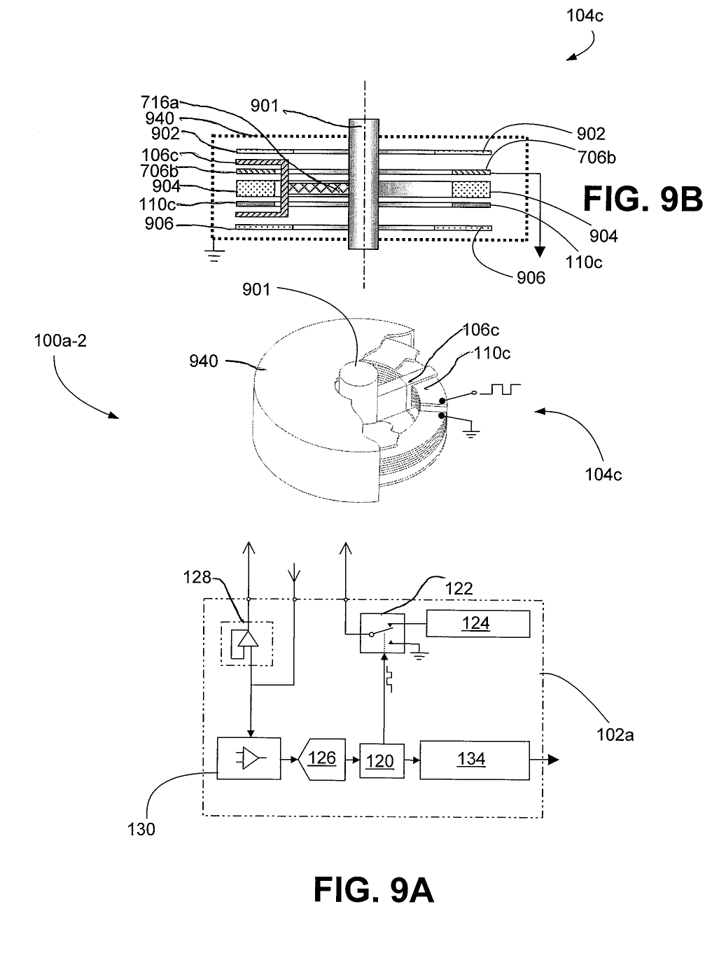

FIG. 9A and 9B provide schematic plus perspective and cross-sectional views, respectively, of another embodiment of a DS system 100a-2. The sensor 104c in this embodiment has a similar layer and signal probe structure as the above displacement sensor embodiment 104b shown in FIGS. 8A and 8B. The DS system 100a-2 comprises the signal conditioning processor 102a, as discussed in association with FIG. 8A, and a displacement sensor embodiment 104c. The displacement sensor 104c, shown in cut-away, comprises a non-continuous, rotary-type sensor. The displacement sensor 104c comprises a cylindrical enclosure 940, which houses a shaft 901. In one embodiment, the signal probe 106c is a “U” shape rigid structure made of either electrically conductive material or non-conductive material with conductive material coated inside the “U”. The signal probe 106c, through an electrically, non-conductive linking member 716a, is rigidly attached the shaft 901. Separated a defined distance from the resistive member (e.g., strip) 110c and the signal strip 706b, the signal probe 106c partially surrounds a structure of layered components. The layered structure comprises (from top to bottom) the inside top surface of the enclosure 940, a shielding layer 902, a first portion of the signal probe 106c, a signal strip 706b, a shielding layer 904, a resistive member 110c, a second portion of the signal probe 106c, a shielding layer 906, and the bottom inside surface of the enclosure 940. The signal probe 106c works as a bridge to capacitively couple the voltage (of the point of the signal probe) on resistive member 110c and bridge the voltage to conductive signal strip 706b (also through capacitance coupling).

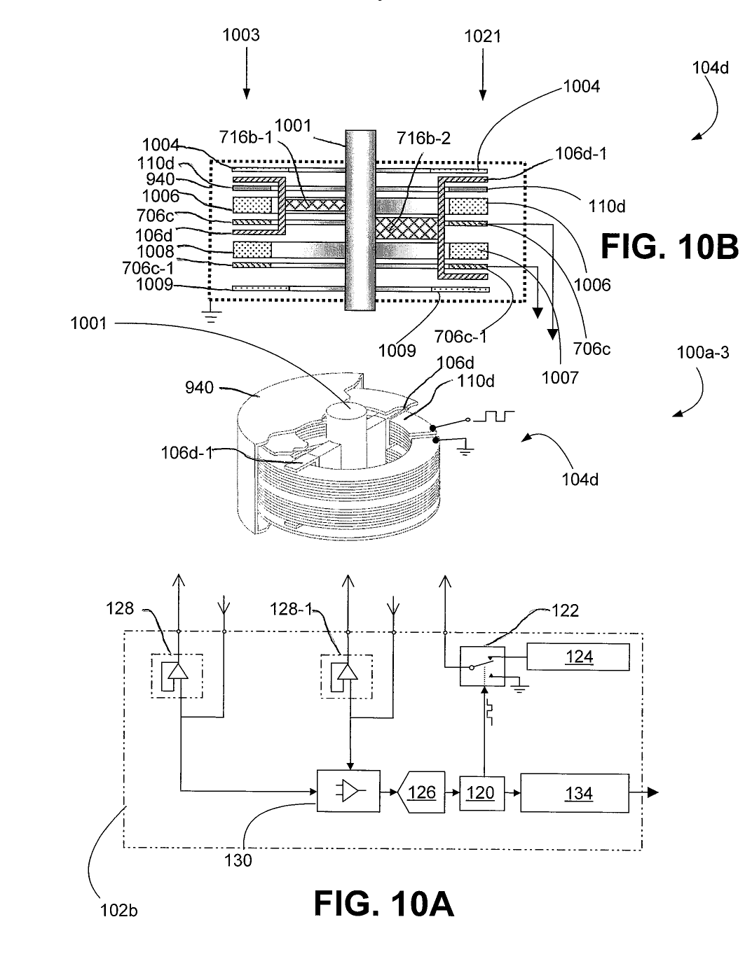

FIGS. 10A and 10B illustrate another DS system embodiment 100a-3 that uses a continuous rotary-type displacement sensor 104d. An embodiment of the signal conditioning processor 102b comprises a similar structure and function as that described above for the signal conditioning processor 102a, with an added shield control 128-1 to provide a second buffered shielded output voltage. With regard to the displacement sensor 104d, the following structure is evident from FIGS. 10A and 10B. The structure of the displacement sensor 104d is similar to a combination of two piled sensors shown in FIGS. 9A and 9B. The displacement sensor 104d comprises a first portion 1003 corresponding to a first signal probe 106d and a second portion 1021 corresponding to a second signal probe 106d-1. The first signal probe 106d and the second signal probe 106d-1 are each attached to a shaft 1001 that rotates the probes 106d and 106d-1 around the shaft through a respective linking member, such as linking member 716b-1 and 716b-2. From the top view (look along the shaft axis), the two linking members are angled from each other in a manner that if one of the signal probes is at the gap of the resistive member 110d, the other is offset a defined angle from that gap. The voltage may be unpredictable at the point of the gap of the resistive strip 706c. Through this sensor embodiment, if one signal probe hits (or is close to) the gap of the resistive member 110d, the signal conditioning processor 102b takes the measurement from the other signal probe. Therefore, the sensor 104d can sense a continuous rotation.

The first portion 1003 is structured in layers with each layer separated a defined distance from each adjacent layer, and comprises (from top to bottom) an inside surface of the enclosure 940, a shielding layer 1004, a first portion of a first signal probe 106d, a resistive member 110d, a shielding layer 1006, a first signal strip 706c, and a second portion of the first signal probe 106d. The first and second portions of the signal probe 106d are connected by a third portion positioned perpendicular to the first and second portions. Following the second portion of the signal probe 106d is a shielding layer 1008, a second signal strip 706c-1, and a shielding layer 1009, followed by the bottom inside surface of the enclosure 940.

Referring to the second portion 1021, a plurality of layered structures (each separated a defined distance in a manner similar to that described for the first portion 1003) are included to provide continuous rotary displacement measurement in cooperation with the first portion 1003. From top to bottom, the layers are as follows. Beneath the inside surface of the enclosure 940 comprises the shielding layer 1004, a first portion of a second signal probe 106d-1, the resistive member 110d, the shielding member 1006, the first signal strip 706c, another shielding member 1007, the second signal strip 706c-1, the second portion of the second signal probe 106d-1, followed by the shielding layer 1009 and then the bottom inside surface of the enclosure 940. Note that, if using buffered shielding technology, the buffered shielding output 1 (from shielding circuit 128) should link to the buffered shielding strips surrounding the signal strip 706c and the buffered shielding output 2 (from shielding circuit 128-1) should link to the buffered shielding strips surrounding the signal strip 706c-1. In that case, shielding layer 1007 may comprise two buffered shielding strips and a grounding strip between those two buffered shielding strips.

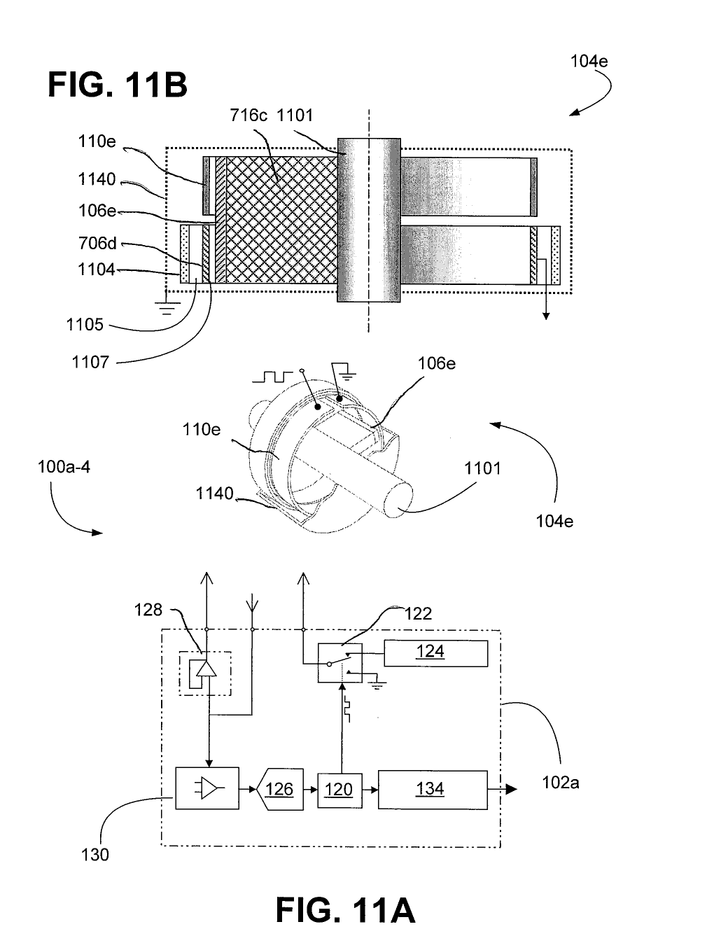

FIGS. 11A and 11B illustrate another DS system embodiment 100a-4 that uses a rotary-type displacement sensor 104e. Description of the signal conditioning processor 102a is provided above, and hence omitted for brevity. The displacement sensor 104e operates under a similar principle to that described for the non-continuous rotary displacement sensor 104b described in association with FIG. 8A, yet with a different construction. In particular, the displacement sensor 104e comprises an enclosure 1140 that houses a shaft 1101 and provides shielding to the inside structures. Inside the enclosure, the shaft is surrounded by a tubular resistive member (e.g., strip) 110e and a tubular electrically conductive signal strip 706d. Referring to the cross-sectional view shown in FIG. 11B, and describing from the outer-most circumference to the shaft 1101 at the center, the inside surface of the enclosure 1140 is followed by a tubular shielding layer 1104, a gap 1105, a tubular signal strip 706d, a gap 1107, and a signal probe 106e bonded to the electrically non-conductive linking member 716c, which is attached to the shaft 1101. Adjacent to and above the signal strip 706d is the tubular resistive member 110e.

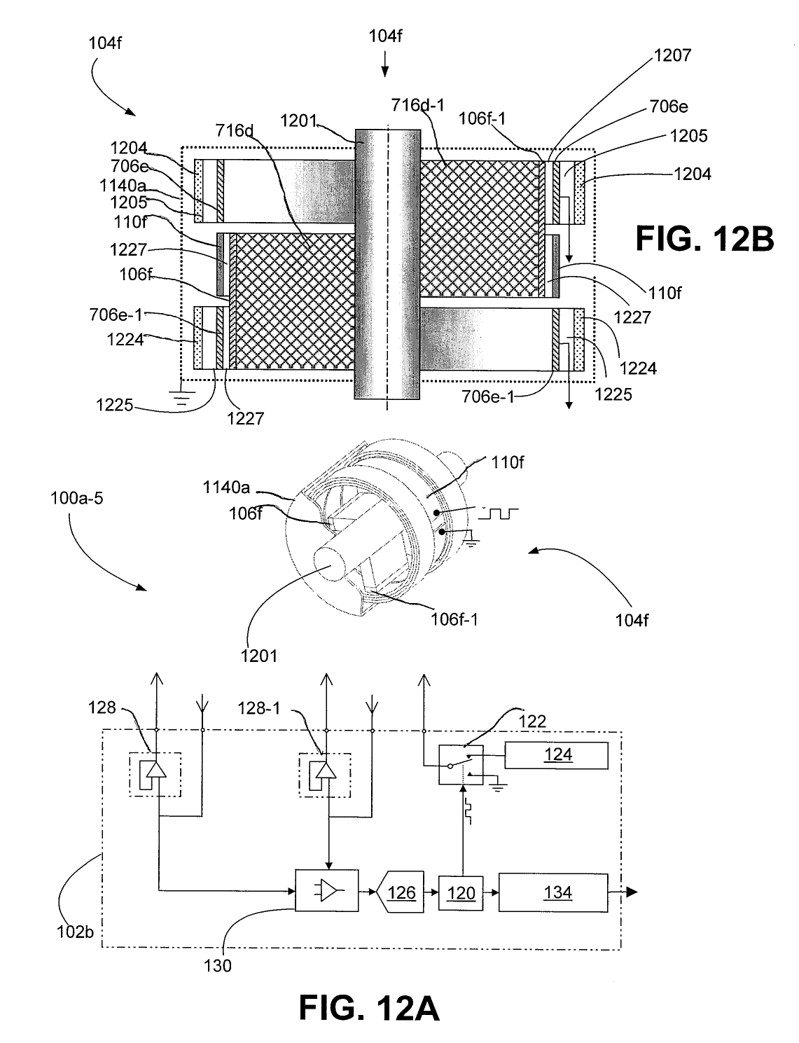

FIGS. 12A and 12B illustrate another DS system embodiment 100a-5 that uses a rotary-type displacement sensor 104f. Description of the signal conditioning processor 102b is provided above, and hence omitted for brevity. The displacement sensor 104f operates under a similar principle to that described for the continuous rotary displacement sensor 104c described in association with FIG. 9A, yet with a different construction that is similar to that described in association with FIGS.10A-10B. The displacement sensor 104f is similar to the combined structure of the two sensor embodiments (shown in FIGS. 11A-11B) piled up along the shaft axis. In particular, the displacement sensor 104f comprises an enclosure 1140a that houses a shaft 1201. The shaft is surrounded by the tubular resistive member (e.g., strip) 110f and tubular signal strips 706e and 706e-1. Referring to the cross-sectional view shown in FIG. 12B, and describing from the outer-most circumference to the shaft 1201 at the center, the inside surface of the enclosure 1140a is followed by a tubular shielding layer 1204, a gap 1205, a first tubular signal strip 706e, a gap 1207, a first signal probe 106f-1, a first linking mechanism that bonds the first signal probe 106f-1 with the shaft 1201. Offset along the shaft axis and beneath the first tubular signal strip, a tubular resistive stripe 110f is deployed with defined gaps 1207 and 1227 between both the first signal probe and the second signal probe. Note that all the tubular structures are concentric. Offset along the shaft axis and beneath the resistive member 110f, describing from the outer-most circumference to the shaft 1201 at the center, the inside surface of the enclosure 1140a is followed by a tubular shielding layer 1224, a gap 1225, a second tubular signal strip 706e-1, a gap 1227, a second signal probe 106f, a second linking mechanism 716d that bonds the second signal probe 106f with the shaft 1201. In FIG. 12B, the two linking members 716d and 716d-1 are shown as if they are configured in a 180 degree angle offset, as opposed to their illustration in FIG. 12A (center of the figure), where they are shown as a 90 degree offset for the sake of illustration.

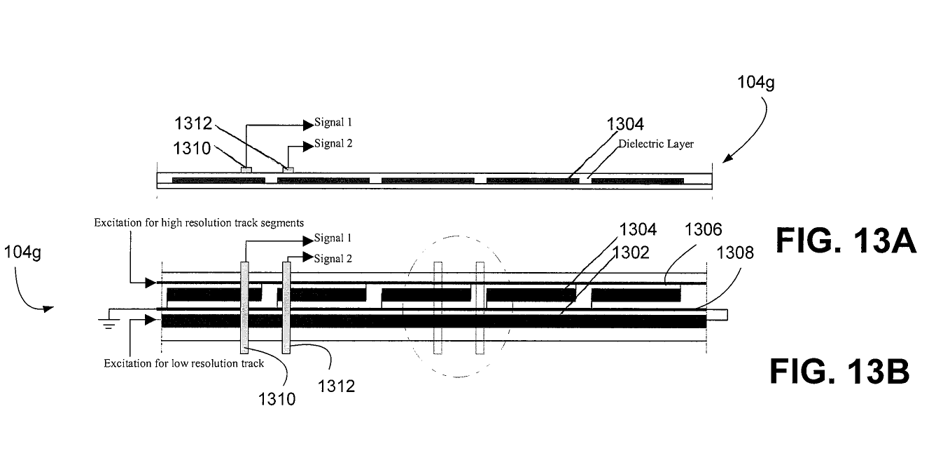

FIGS. 13A-13B illustrate another embodiment of a displacement sensor 104g, with FIG. 13A providing a side view and FIG. 13B providing a top view. CCRS technology (also referred to herein as capacitively coupled position transducer (CCPT) technology)-based sensors deliver a voltage at the pickup head whose amplitude is linearly dependant on the relative position of the pickup head along the length of the resistive, energized material. While the resolution of the CCRS transducer is unlimited, there is a practical limit to the resolution as a result of noise generated within the system (the transducer itself as well as the signal conditioning electronics—whether traditional LVDT type conditioning or square wave conditioning as discussed above).

Additionally, in cases where an analog to digital converter is used (whether for the actual conditioning as mentioned above, or from the output of traditional conditioning) in the system, this also may serve to limit the resolution as the length of the sensor increases. By way of example, a 16 bit D/A converter yields 65,536 different values along the length of the sensor (as the output voltage varies linearly along the movement of the sensor). If the range of motion for the sensor is 65 mm, this yields an effective resolution (assuming the D/A conversion is the bottleneck with the signal to noise ratio high enough to not cause its own issues) for the system of about 1 micron. However, the same system when used with a CCRS transducer that is 65 meters should only be able to provide measurements to a 1 millimeter resolution. Parallel arguments can be made regarding the signal to noise ratio as the transducer lengthens, so the above issue can apply even if the system is pure analog and never utilizes a D/A conversion.

To compensate for this loss of resolution as the transducer is lengthened, improvements have been developed, as shown by the embodiment 104g in FIGS. 13A and 13B. The approach is to rely on more than one track (also known as a resistive strip) of excitation material. One continuous track 1302 provides a gross level measurement (using standard CCRS techniques). Because it runs the entire length of the desired measurement, it exhibits the limited resolution as described above. However, a separate track 1304 made up of smaller, discrete segments arranged end-to-end provides much higher resolution measurements (but only over the distance of a single segment). Each of the smaller segments is tied to a common excitation rail 1306 (also known as an excitation strip, a conductive strip used to deliver the excitation power to the appropriate end of each/any segment of the high resolution strip/track) and a common ground rail 1308. There are then two pickup heads 1310 and 1312 that are mounted (directly or indirectly) to the moving body that is being measured. These pickup heads 1310 and 1312 are separated by a known displacement that is specifically different from the distance between the start of adjoining segments in 1304 (the length of a segment plus the length of the gap between segments in 1304), but greater then the length of the gap between segments in 1304. Generally the gap should be smaller then the segment size, yielding an overall pickup system that simultaneously senses more then one signal from the same or adjoining segments. In this embodiment, each signal pickup head 1310 and 1312 is wide enough to read from both the high 1304 and low 1302 resolution tracks. The signal conditioning processor 102 can alternate excitation pulses between the two tracks, allowing for each pickup head 1310 and 1312 to alternately sense the voltage amplitudes from each of the tracks via capacitive coupling as any other CCRS sensor.

This yields two different voltages for the signal conditioning processor 102. The signal conditioning processor 102 then uses the voltage from the low resolution track 1302 to determine which high resolution segment the head is over. This is used to determine an offset that is added to the precise measurement that is derived from the voltage measured from the precision track. Without the low resolution track, the system would have no way of knowing which segment the read head was over. By combining the two, the precision of smaller segments can be obtained over a virtually unlimited overall length (and the system allows for a common voltage/ground, without having to independently wire each of the small segments).

The system utilizes two read heads 1310 and 1312 because of the small dead spots along the precise track in between each segment. If the read head were positioned directly over one of the dead spots between the small segments, there would be no precise measurement generated, yielding gaps in the precision measurement. In order to compensate for this, the two pickups 1310 and 1312 ensure that a valid read can always be obtained—if one pickup is over a dead spot and the gap between the pickups are offset from each other by some distance other then the segment size, when one pickup is over a gap, the other must be over a valid segment of the high precision track 1304.

As an alternative to the above approach for compensating for the dead spots in the high resolution track 1304, two offset high resolution tracks could be employed and only a single read head. In this alternative, the system is guaranteed to have the single read head over a valid segment of at least one of the high resolution tracks. The system would alternate between energizing all three tracks (low resolution and the two high resolution tracks). The two high resolution values can be used for the precise positioning, with the system still functioning even if the pickup happens to be over a dead spot on one of the tracks.

In the system shown in FIGS. 13A and 13B, each pickup head spans the width of all the tracks and receives values from all the tracks as the excitation voltage is cycled across each of the tracks. This requires the pickup heads and the tracks to be alongside each other (which could in some situations be mechanically inappropriate or cumbersome) and also requires the signal conditioning processor 102 to excite each track in turn (which limits the system bandwidth since it takes an independent read time for each of the tracks to yield a single measurement). If these limitations are problematic, one can also use independent pickups for each track. This removes the requirement for the tracks to be directly next to each other as well as allowing for simultaneous excitation and reading from each of the tracks.

It should be noted that the small segments can be energized with the same orientation along the length of the track or alternating polarity. From a processing perspective, either works (as long as the signal conditioning processor 102 knows which approach is being utilized). However, reversing the polarity on each subsequent segment can have manufacturing advantages since the number of connections between the excitation rail and the voltage/ground rail can be reduced, and the size of the dead spot between the segments can be minimized (every periodic distance, a single contact can be used to tie it to either the ground or voltage—with a given contact serving as the beginning of one segment and the end of the next). In the reversing polarity scenario, the precision track 1304 can be made by taking a continuous track (just like the low precision track 1302) and alternating conductive connections to the ground and voltage tracks.

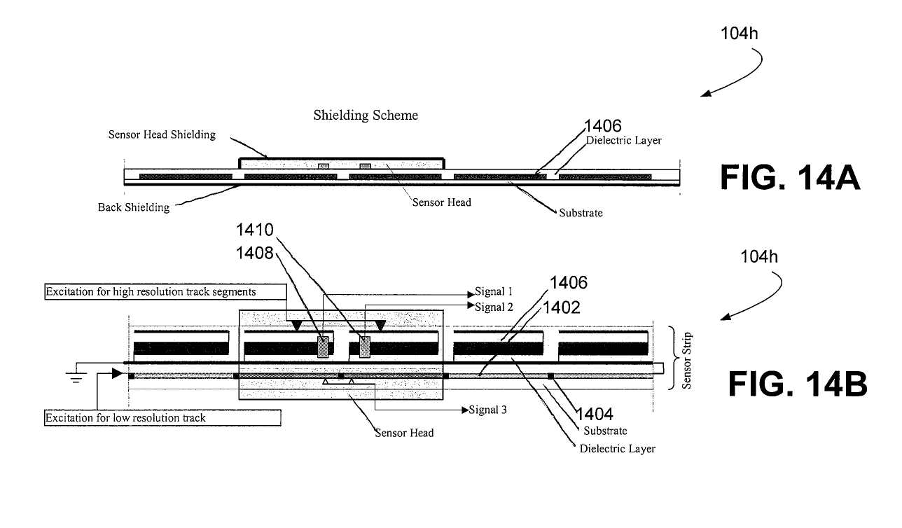

FIGS. 14A and 14B illustrate another embodiment of a displacement sensor 104h, with FIG. 14A illustrating an exemplary shielding scheme and FIG. 14B providing a top view of FIG. 14A. The long stroke form factor technique described in association with FIGS. 13A and 13B provide a basic realization of a long stroke displacement sensor scheme based on CCRS sensor. However, in using displacement sensor 104g, two challenges exist: 1) all the tracks are excited at the same time, which increase the power dissipation and EM emission (the tracks are actually emitting EM noises like antennas); 2) capacitance between tracks and ground (e.g. machine frame) reduces the excitation bandwidth and thus limits the sensing bandwidth.

To solve these problems, a solution in the form of displacement sensor 104h is disclosed as shown in FIGS. 14A and 14B. Several improvements are made. For instance, a conductive backplane (e.g., the back-shielding below the substrate) is provided for the sensing strip for shielding. The resistive low resolution track is replaced by a track of conductive segments 1402. These segments are linked together serially by resistors 1404 between every two conjunct segments. These segments are physically contacted by the sensor head by means of contacting mechanisms (for example, but not limited to, a conductive wipe). The thin conductive segments impose a very small capacitance because of their small area (< 1/10 of that of a resistive track). Resistors 1404 between these segments provide voltage differences that can be used to index the high resolution track segments. Only the two high resolution track sections 1406 that are used by the pickup heads 1408 and 1410 are excited by the sensor head. The two excited high resolution track segments 1406 are shielded by the sensor head. The low resolution track segments 1402 are shielded by a metal sheet or other mechanisms.

In some embodiments, long range potentiometers can be utilized. The previously discussed long-range form factor concepts (specifically the long range form factor approach of increasing overall resolution by creating a series of high resolution tracks while using a low resolution track to indicate which high resolution track the read head is over) can also be used with traditional linear potentiometer technology.

Potentiometers exhibit similar limitations if used for long stroke lengths. By utilizing the above schemes, but in a contacting fashion rather then using the CCRS principals, potentiometers can be created that can span virtually unlimited lengths.

Additionally, similar low-power concepts can be utilized as well, only energizing the segments that are appropriate (through mechanical contacting means) and only energizing when a read is desired. Further, in some embodiments, another approach to the long range form factor, while still maintaining the superior characteristics of the CCRS sensors is to create a hybrid sensor whereby the low resolution track utilizes potentiometric principles, relying on CCRS technology for the high resolution track(s). The head would have a contacting potentiometric wiper that would slide along the lower resolution potentiometric track. Since potentiometers utilize a voltage divider principal, an alternating voltage is not required. This allows the entire long, low resolution track to be energized with a DC voltage (which would remove the need to shield the low resolution track).

In such a scenario, similar to the moving energizing and shielding method described earlier, sliding contacts could be employed in the read head to make contact with voltage/ground strips that are alongside the track segments but not connected between the different segments. In this way, the contacts in the head can energize only the one or two segments that the head is over (and is physically shielding). This avoids the stray EM generation mentioned in the previous section.

In doing this, even if the repeatability and accuracy of the contacting potentiometer degrades over time, it has little impact on the repeatability and accuracy of the overall system. The potentiometer is only used to determine which high resolution segment is being used. Additionally, by using a constant polarity along the length of the high resolution segment (e.g.,the high resolution segments all start with ground and end with the excitation voltage or vice versa—but do not alternate between starting with ground and starting with the voltage), even relatively large errors from the low resolution track can be overcome.

Ideally, the low resolution track directly indicates the appropriate track (by delivering a reading that is anywhere within the bounds of the correct track). However, even if it gave an erroneous reading that was slightly beyond the correct segment, the system could correct for it since it should be known from the high resolution value that, for example, the head is really at the end of a segment not at the beginning of the next. An appropriate threshold or safety margin can be incorporated so that, for example, any time the low resolution track indicates a read within 10% of the beginning of a high resolution segment, but the high resolution read indicates a value within 10% of the end of a segment, the low resolution reading will be assumed to have “overshot” and the previous segment will be assumed. A similar process can be applied to the beginning of the segments. The 10% buffer is simply an example—specific buffer on each end can be optimized based on the specifics of the sensor system and application.

The various embodiments of the signal conditioning processor 102 can be implemented in hardware, software, firmware, or a combination thereof. Note that signal conditioning processor 102 can be implemented as a single microprocessor, or with like functionality of the same distributed among two or more discrete or separate components. Hardware implementations include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. Software implementations can be realized as an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In addition, the scope of the certain embodiments includes embodying the functionality of the preferred embodiments in logic embodied in hardware or software-configured mediums.

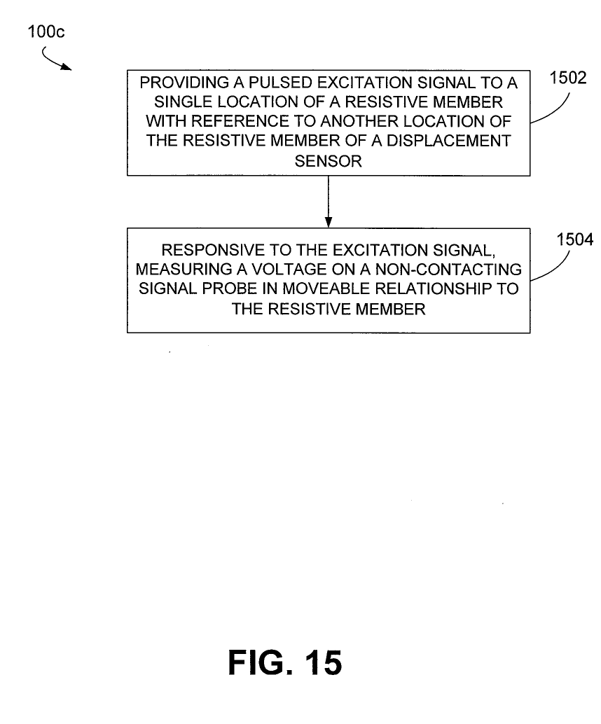

Having described various DS system embodiments above, it should be appreciated that one method embodiment 100c shown in FIG. 15 comprises providing a pulsed excitation signal to a single location of a resistive member with reference to another location of the resistive member of a displacement sensor (1502), and responsive to the excitation signal, measuring a voltage on a non-contacting signal probe in moveable relationship to the resistive member (1504).

Any process descriptions or blocks in flow charts should be understood as representing modules, segments, or portions of code which include one or more executable instructions for implementing specific logical functions or steps in the process, and alternate implementations are included within the scope of the preferred embodiment in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the disclosed principles. Many variations and modifications may be made to the above-described embodiment(s) without departing substantially from the spirit and principles of the disclosure. All such modifications and variations are intended to be included herein within the scope of this disclosure and protected by the following claims.

1. A method, comprising:
providing a pulsed excitation signal to a single location of a resistive member with reference to another location of the resistive member of a displacement sensor; and
responsive to the excitation signal, measuring a voltage on a non-contacting signal probe in moveable relationship to the resistive member.

2. The method of claim 1, wherein providing the pulsed excitation signal comprises providing a square waveform voltage or a voltage that has a fast rising edge and a constant value after the rising edge.

3. The method of claim 1, wherein providing the pulsed excitation signal comprises providing to one end of the resistive member with reference to ground.

4. The method of claim 1, wherein measuring the voltage comprises measuring a stabilized voltage on the signal probe.

5. The method of claim 1, wherein providing the pulsed excitation signal comprises providing the pulsed excitation signal at a fixed peak-to-peak amplitude.

6. The method of claim 1, further comprising imposing an adjustable measuring impedance prior to measuring the voltage on the signal probe.

7. The method of claim 1, further comprising fully discharging the signal probe prior to providing the pulse excitation.

8. A system, comprising:
a displacement sensor having a resistive member and a non-contacting signal probe; and
a processor configured to provide a pulsed excitation signal to a single location of the resistive member, the processor further configured to measure a voltage on the probe caused by the excitation.

9. The system of claim 8, wherein the processor is further configured to provide a square waveform voltage signal or a voltage waveform that has a fast rising edge and a constant value after the rising edge.

10. The system of claim 9, wherein the measured voltage corresponds to a probe position along the resistive member.

11. The system of claim 8, wherein the processor is further configured to measure the voltage on the probe when the voltage fully stabilizes.

12. The system of claim 8, wherein the processor is further configured to fully discharge the electric charge on the probe before applying excitation.

13. The system of claim 8, wherein the processor is further configured to terminate the excitation after the measurement of the voltage on the signal probe.

14. The system of claim 8, further comprising an amplifier configured to amplify a signal received from the displacement sensor.

15. The system of claim 8, further comprising a buffered signal output circuit configured to output the voltage on the signal probe to conductive buffered shielding strips.

16. The system of claim 8, further comprising an analog to digital converter configured to convert a signal carrying the measured voltage from an analog domain to a digital domain.

17. The system of claim 8, wherein the processor comprises a micro-controller.

18. The system of claim 8, further comprising an impedance network controlled by the processor, the impedance network adjustably configured by the processor to impose a desired measurement impedance during the measurement of the voltage on the probe.

19. The system of claim 18, wherein the impedance network comprises one or more resistors, one or more capacitors, or a combination of both.

20. The system of claim 8, further comprising signal conditioning components and a communications interface, the signal conditioning components configured to prepare a signal for delivery to a user by the communications interface.

21. The system of claim 8, wherein the displacement sensor comprises a signal strip, the resistive member, and the signal probe in moveable relationship to and capacitively coupled to both the signal strip and the resistive member.

22. The system of claim 21, wherein the signal strip, the resistive member, and the signal probe are at least partially enclosed in an electrically grounded enclosure.

23. The system of claim 21, further comprising one or more shielding layers arranged to shield the signal strip and signal probe from internal and external interference.

24. The system of claim 23, wherein at least one of the shielding layers comprises an electrically conductive and grounded strip, or an electrically conductive buffered shielding strip, or both.

25. The system of claim 8, wherein the displacement sensor comprises a non-continuous rotary displacement sensor further comprising a shaft to support the signal probe.

26. The system of claim 8, wherein the displacement sensor comprises a continuous rotary displacement sensor further comprising a shaft supporting the signal probe and a second signal probe, the second signal probe in moveable relationship to and capacitively coupled to both a signal strip and the resistive member. 27. A system, comprising:
means for providing a pulsed excitation signal to a single location of a resistive member with reference to another location of the resistive member of a displacement sensor; and
responsive to the excitation signal, means for measuring a voltage on a non-contacting signal probe in moveable relationship to the resistive member.
